(19) United States
(12) Patent Application Publication
(10) Pub. No.: US 2017/0116950 A1
(43) Pub. Date: Apr. 27, 2017

(54) LIQUID CRYSTAL DISPLAY WITH VARIABLE DRIVE VOLTAGE

(71) Applicant: Google Inc., Mountain View, CA (US)

(72) Inventor: Caner Onal, Palo Alto, CA (US)

(21) Appl. No.: 14/920,466

(22) Filed: Oct. 22, 2015

(51) Int. Cl. G09G 3/36; G02B 27/01; G06T 19/00

(52) U.S. Cl. CPC G09G 3/3696; G06T 19/006; G02B 27/017; G02B 2027/0178; G09G 2320/0626

(57) ABSTRACT

A technique for operation of a display system includes displaying a display image from a liquid crystal display source, measuring a brightness of ambient light, and selecting a drive voltage for driving liquid crystal cells within the liquid crystal display source based upon the brightness of the ambient light. The drive voltage is used for driving the liquid crystal cells into an on-state or an off-state while displaying the display image.

### TECHNICAL FIELD

This disclosure relates generally to liquid crystal based displays, and in particular but not exclusively, relates to near-to-eye optical systems with liquid crystal based displays.

### BACKGROUND INFORMATION

A head mounted display (“HMD”) or head wearable display is a display device worn on or about the head. HMDs usually incorporate some sort of near-to-eye optical system to create a magnified virtual image placed a few meters in front of the user. Single eye displays are referred to as monocular HMDs while dual eye displays are referred to as binocular HMDs. Some HMDs display only a computer generated image (“CGI”), while other types of HMDs are capable of superimposing CGI over a real-world view. This latter type of HMD typically includes some form of see-through eyepiece and can serve as the hardware platform for realizing augmented reality. With augmented reality the viewer's image of the world is augmented with an overlaying CGI, also referred to as a heads-up display (“HUD”).

HMDs have numerous practical and leisure applications. Aerospace applications permit a pilot to see vital flight control information without taking their eye off the flight path. Public safety applications include tactical displays of maps and thermal imaging. Other application fields include video games, transportation, and telecommunications. There is certain to be new found practical and leisure applications as the technology evolves; however, many of these applications are limited due to the cost, size, weight, field of view, and efficiency of conventional optical systems used to implemented existing HMDs.

In see-through HMDs that use liquid crystal based microdisplays to generate the display image, it can be difficult to design the display with both good brightness and high contrast. These characteristics are often at tension with each other and tradeoffs between the two are usually required. In an outdoor setting with high ambient brightness, the displayed see-through image can become illegible and a very high brightness from the display is often required. Conversely, in an indoor setting, the contrast of the displayed image becomes more important. In conventional display architectures, the intrinsic properties of the liquid crystal display are fixed in hardware, and opportunities to adapt to environmental conditions are limited. Furthermore, in very small pixel size microdisplays (e.g., <20 um), the electrical crosstalk between neighboring pixels becomes a significant issue and is usually tied to the driving voltage of the liquid crystal display. This crosstalk can compromise the ability of the liquid crystal display to show good quality images and can degrade color gamut as well.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. The drawings are not necessarily to scale, emphasis instead being placed upon illustrating the principles being described.

FIG. 1 is a functional block diagram illustrating a display system having a variable drive voltage for driving liquid crystal cells of a liquid crystal display panel, in accordance with an embodiment of the disclosure.

FIG. 2A is a flow chart illustrating a process for adjusting a drive voltage for driving liquid crystal cells of a normally-on liquid crystal display panel based upon ambient light brightness, in accordance with an embodiment of the disclosure.

FIG. 2B is a flow chart illustrating a process for adjusting a drive voltage for driving liquid crystal cells of a normally-off liquid crystal display panel based upon ambient light brightness, in accordance with an embodiment of the disclosure.

FIGS. 3A and 3B illustrate a demonstrative monocular head wearable display including a see-through eyepiece, in accordance with an embodiment of the disclosure.

FIG. 3C illustrates a demonstrative binocular head wearable display including see-through eyepieces, in accordance with an embodiment of the disclosure.

### DETAILED DESCRIPTION

Embodiments of an apparatus, system and method of operation for a liquid crystal based display having variable drive voltage for driving liquid crystal cells are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

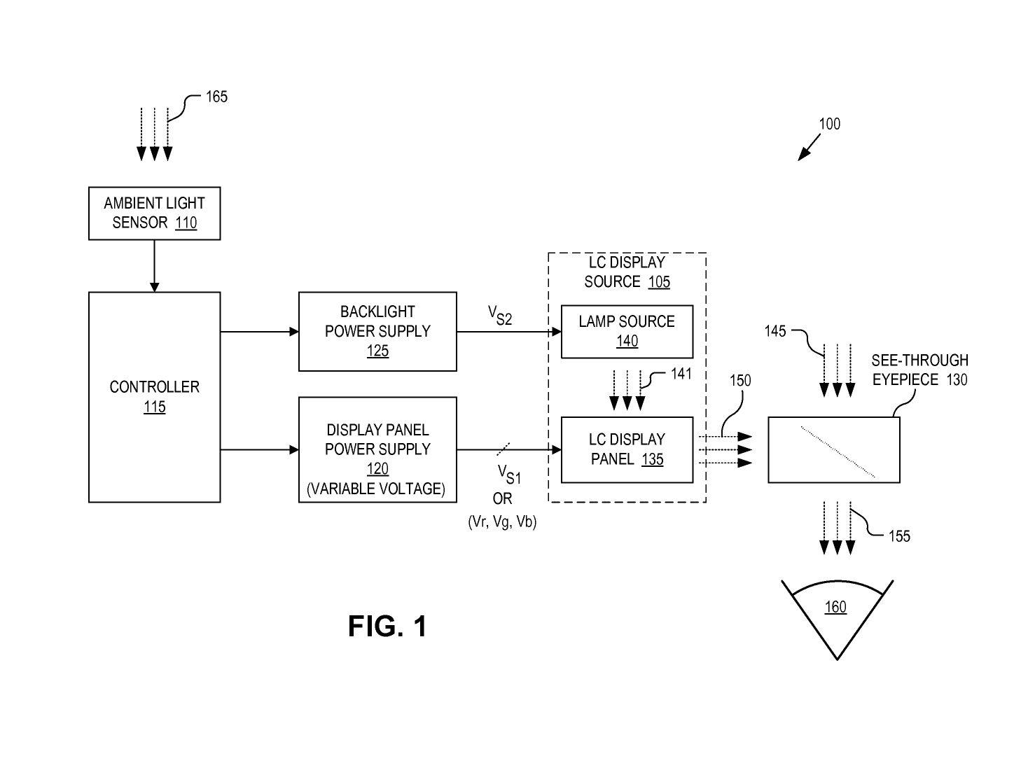

FIG. 1 is a functional block diagram illustrating a display system 100 having a variable drive voltage for driving liquid crystal cells of a liquid crystal display panel, in accordance with an embodiment of the disclosure. The illustrated embodiment of display system 100 includes a liquid crystal (“LC”) display source 105, an ambient light sensor 110, a controller 115, a display panel power supply 120, a backlight power supply 125, and a see-through eyepiece 130. The illustrated embodiment of LC display source 105 includes a LC display panel 135 and a lamp source 140.

Ambient light sensors have been used in consumer electronic devices. They typically provide feedback to the system in determining the environmental conditions in regards to external illumination and adjust the brightness of the display screen in order to ensure legibility indoors or outdoors. While this technology has been widely implemented, it does not enhance the intrinsic capabilities of the display device itself, but rather, is conventionally used to simply adjust the brightness of the backlight in response to the background illumination.

Embodiments described in this disclosure implement a driving scheme that uses variable drive voltages for driving the liquid crystal cells of liquid crystal based display panels. Ambient light sensor 110 is used to detect and measure the brightness or illumination level of ambient light 165. Controller 115 is coupled to ambient light sensor 110 to process and interpret the measurement signals from ambient light sensor 110. In response, controller 115 executes logic to scale or otherwise adjust the drive voltage V_{S1} that drives the liquid crystal cells within LC display panel 135. In other words, the maximum drive voltage range and the gamma curve of the LC display panel 135 are scaled in response to the ambient brightness. In conventional liquid crystal displays the gamma curve and voltages are fixed values that do not change based upon ambient brightness. For typical non-see-through displays a fixed gamma curved with pre-determined drive voltages is acceptable since the displays themselves are opaque and ambient light does not shine through. However, for see-through displays the ambient brightness degrades image perception directly and significantly.

The adjustments to drive voltage V_{S1} operate to enable different modes of operates (e.g., outdoor mode/high brightness mode or indoor mode/low brightness mode/high contrast mode). These different modes of operation use different voltage levels for drive voltage V_{S1} to achieve improved performance from LC display panel 135 given the environmental condition at a given moment.

The techniques described herein exploit intrinsic properties of LC display panel 135 and enable dynamic adjustment of the LC cell voltage based upon ambient brightness. This provides a method to adjust the properties of the display panel dynamically and improve brightness in environments where more brightness is desirable and improve contrast in dark environments. This dynamic, real-time adjustment of LC driving voltage (V_{S1}) provides a mechanism to save power consumption by a normally-on LC display panel 135 in bright environmental conditions (e.g., outdoor environments) while improving contrast in low light environments (e.g., indoor environments). Adjustment of the voltage level of drive voltage V_{S1} enhances the intrinsic capabilities of liquid crystal based displays and is independent of and/or in addition to any dynamic adjustment to backlighting (e.g., lamp source 140) using feedback from ambient light sensor 110.

Furthermore, electrical crosstalk in liquid crystal microdisplays with small pixel dimensions (e.g., <20 um) can be a serious problem. With the aspect ratio of a liquid crystal pixel cell to inter-cell gap becoming comparable, the electric field is no longer confined to one liquid crystal cell. High drive voltages for driving LC display panels can exacerbate the issue. Embodiments disclosed herein can help mitigate the undesirable effects of this crosstalk by dynamically reducing the drive voltage for driving the LC cells when the external conditions allow doing so. This enhances the intrinsic capabilities of a LC display panel.

Ambient light sensor 110 may be implemented using various photo-electric devices including photo-sensors (e.g., CMOS image sensor, CCD image sensor), one or more photo-diodes, one or more photo-voltaic cells, or other photo-sensitive devices. In various embodiments, controller 115 may be implemented entirely as hardware logic (e.g., application specific integrated circuit, FPGA, logic gates, etc.), as software/firmware logic that is executed on a microprocessor, or a combination of both.

LC display source 105 is a liquid crystal based display, which may be implemented as a front or rear illuminated display. For example, LC display source 105 may be a backlit liquid crystal display (“LCD”) or a front illuminated liquid crystal on silicon (“LCoS”) display. Other silicon based display technologies may also be used. LC display panel 135 may be implemented using “normally-on” LC cells that pass lamp light 141 without application of drive voltage V_{S1} across a LC cell and block lamp light 141 when drive voltage V_{S1} is applied across a LC cell. Alternatively, LC display panel 135 may be implemented using “normally-off” LC cells that block lamp light 141 without application of drive voltage V_{S1} across a LC cell and pass lamp light 141 when drive voltage V_{S1} is applied across a LC cell. Lamp source 140 provides illumination of LC display panel 135 and may be implemented with any number of lamp technologies (e.g., LED lamp, florescent lamp, quantum dot emission lamp, halogen lamp, high intensity discharge lamp, etc.).

Display system 100 is well-suited for integration with a head wearable display systems that include a see-through eyepiece 130 for combining an external scene image 145 with a display image 150 to generate a combined image 155 output along an eye-ward direction towards the user's eye 160. In other words, see-through eyepiece 130 operates as an optical combiner and may be implemented using a variety of different optical combining technologies including conventional beam splitters, polarizing beam splitters, diffraction based combiners (e.g., diffraction grating, holographic optical elements), various reflective/refractive light bending systems, or otherwise. Furthermore, see-through eyepiece 130 may be incorporated into a free-space head wearable display, a lightguiding head wearable display, or otherwise. In yet other embodiments, display system 100 may omit see-through eyepiece 130 and be incorporated into other types of portable display systems that are not worn on a user's head (e.g., cellular phone displays, tablet computer displays, laptop computer displays, etc.).

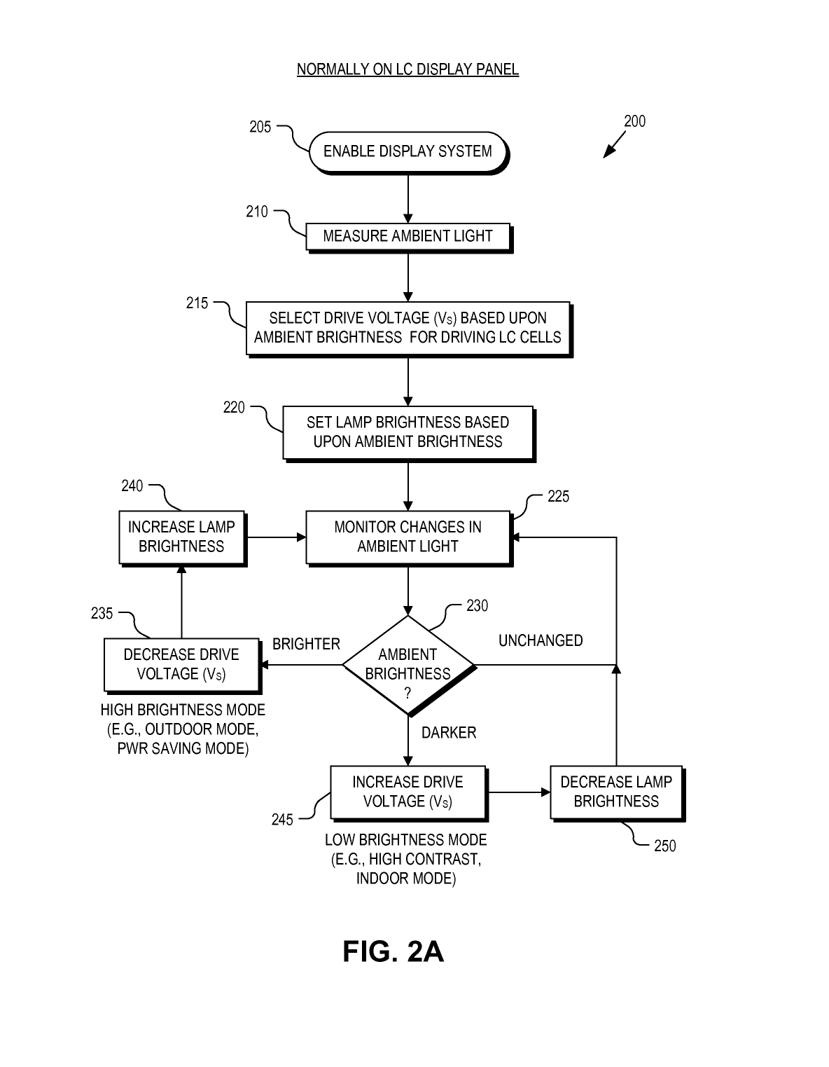

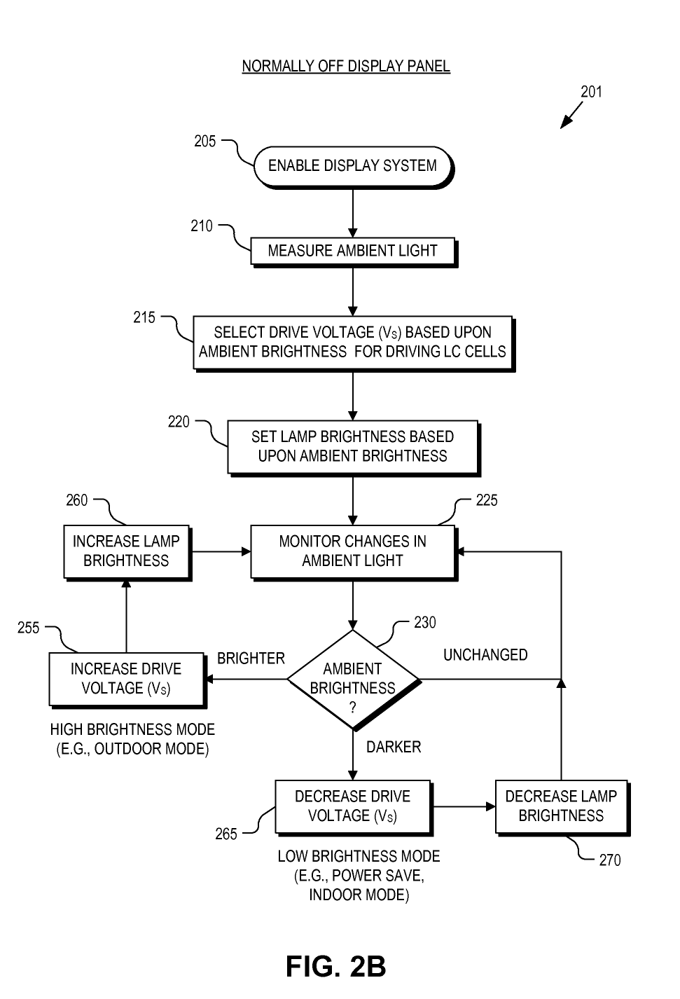

FIG. 2A is a flow chart illustrating a process 200 for adjusting a drive voltage for driving LC cells of a normally-on LC display panel based upon the brightness of ambient light, in accordance with an embodiment of the disclosure. Process 200 is described with reference to display system 100 illustrated in FIG. 1. The order in which some or all of the process blocks appear in process 200 should not be deemed limiting. Rather, one of ordinary skill in the art having the benefit of the present disclosure will understand that some of the process blocks may be executed in a variety of orders not illustrated, or even in parallel.

In a process block 205, display system 100 is powered on or its operation is otherwise enabled. In a process block 210, ambient light sensor 110 commences measuring the brightness of ambient light 165. In one embodiment, ambient light sensor 110 is positioned and oriented relative to see-through eyepiece 130 to measure ambient light 165 that is incident along an eye-ward direction and within a field of view (“FOV”) of see-through eyepiece 130. This orientation is well-suited for head wearable displays since it ensures that ambient light sensor 110 is approximately sensing the same ambient brightness as is incident upon see-through eyepiece 130 and thus affecting display light 150. For example, positioning ambient light sensor 110 in a forward orientation adjacent to see-through eyepiece 130 accounts for scenarios where the user is facing a bright light source (e.g., looking in the direction of the sun low on the horizon). In certain embodiments, it may also be possible to position ambient light sensor 110 in other directions (e.g., upward facing). Furthermore, in some embodiments, ambient light sensor 110 is not limited to measuring the brightness of light within the user's FOV as ambient light from steeper angles can still affect the user's pupil and vision. In response to measuring the brightness of ambient light 165, ambient light sensor 110 outputs a signal to controller 115 that is indicative of this brightness value or luminosity reading.

In a process block 215, controller 115 selects a voltage level for drive voltage V_{S1} based upon the brightness measured by ambient light sensor 110. In other words, the drive voltage V_{S1} that would otherwise be applied to a given LC cell is scaled based upon the ambient brightness. In one embodiment, this scaling affects the gamma curve for the LC crystal display panel 135. LC display source 105 uses the drive voltage V_{S1} to drive the LC cells within LC display panel 135 into an on-state or off-state while generating display image 150. Display panel power supply 120 may be implemented as an analog circuit, a digital circuit, or a hybrid analog/digital circuit. Display panel power supply 120 receives a control signals from controller 115 and outputs drive voltage(s) V_{S1} with a selected voltage level in response to the control signal output from controller 115. In one embodiment, display panel power supply 120 is implemented as a power regular with variable voltage settings.

In the embodiment illustrated in FIG. 1, display system 100 also includes a backlight power supply 125 to provide independent control of lamp source 140. Backlight brightness control is an optional feature that can be independently controlled from the variable voltage control of LC display panel 135. In a process block 220, controller 115 selects a brightness level for lamp source 140 based upon the ambient brightness signal received from ambient light sensor 110. In the illustrated embodiment, controller 115 outputs a control signal to backlight power supply 125, which regulates the drive voltage V_{S2} that drives lamp source 140. Other mechanisms for controlling the brightness of lamp source 140 may also be implemented.

In a process block 225, controller 115 continues to monitor the brightness signal output from ambient light sensor 110 for changes in the measured brightness of ambient light 165. In a decision block 230, if controller 115 determines that ambient brightness has increased, then process 200 continues to a process block 235. In one embodiment, controller 115 waits for threshold level changes in the ambient brightness before instructing display panel power supply 120 to change the voltage level of drive voltage V_{S1}. Since process 200 describes operation of display system 100 implemented with a LC display panel 135 having normally-on LC cells, the drive voltage V_{S1} is decreased in process block 235. Decreasing the voltage level of drive voltage V_{S1} causes the LC cells to block less lamp light 141 for a given image value resulting in a brighter display. Decreasing drive voltage V_{S1} for a normally-on LC display can be viewed as a high brightness mode or an outdoor mode of operation for display system 100. In a process block 240, the brightness of lamp light 141 output from lamp source 140 can also be increased to further increase the overall brightness of image light 150 in bright, outdoor environments. Reducing the voltage level of drive voltage V_{S1} also servers to reduce power consumption.

Returning to decision block 230, if controller 115 determines that ambient brightness has decreased, then process 200 continues to a process block 245. Since process 200 describes operation of display system 100 implemented with a LC display panel 135 having normally-on LC cells, the drive voltage V_{S1} is increased in process block 245. Increasing the voltage level of drive voltage V_{S1} causes the LC cells to block more lamp light 141 for a given image value resulting in a dimmer display, which provides higher contrast. Increasing drive voltage V_{S1} for a normally-on LC display can be viewed as a low brightness mode, high contrast mode, or an indoor mode of operation for display system 100. In a process block 250, the brightness of lamp light 141 output from lamp source 140 can also be decreased to further decrease the overall brightness of image light 150 in low light, indoor environments.

Controller 115 may operate to continuously monitor ambient light sensor 110 and update drive voltage(s) V_{S1} and V_{S2} in real-time. The variable voltage changes to drive voltage(s) V_{S1} and/or V_{S2} can be continuous smooth analog changes (e.g., continuous adjustment by variable amounts) or multi-level changes having pre-determined amounts. In one embodiment, the adjustments to drive voltage V_{S1} for a given image value may have just two level changes that are dependent upon ambient brightness corresponding to a high brightness mode and a low brightness mode. In other embodiments, the adjustments to the drive voltage V_{S1} for a given image value are more granular and may include multiple levels (e.g., two, three, four, etc.) of adjustment to the drive voltage V_{S1} each corresponding to a different level of ambient brightness. Accordingly, for a normally-on LC panel, the scaling of drive voltage V_{S1} affects the drive voltages applied to the entire LC display panel 135 to turn off selected LC cells. The scaling is applied across the entire gamma curve and affects LC cells that are entirely off or partially off according to the particular image value they are currently representing.

FIG. 2B is a flow chart illustrating a process 201 for adjusting a drive voltage for driving liquid crystal cells of a normally-off liquid crystal display panel based upon ambient light brightness, in accordance with an embodiment of the disclosure. Process 201 is described with reference to display system 100 illustrated in FIG. 1. The order in which some or all of the process blocks appear in process 201 should not be deemed limiting. Rather, one of ordinary skill in the art having the benefit of the present disclosure will understand that some of the process blocks may be executed in a variety of orders not illustrated, or even in parallel.

Process blocks 205 to 230 operate in the same manner as described above in connection with process 200. Accordingly, discussion of process 201 commences with decision block 230. In decision block 230, if controller 115 determines that ambient brightness has increased, then process 201 continues to a process block 255. In one embodiment, controller 115 waits for threshold level changes in the ambient brightness before instructing display panel power supply 120 to change the voltage level of drive voltage V_{S1}. Since process 201 describes operation of display system 100 implemented with a LC display panel 135 having normally-off LC cells, the drive voltage V_{S1} is increased in process block 255. Increasing the voltage level of drive voltage V_{S1} causes the LC cells to block less lamp light 141 for a given image value resulting in a brighter display. Increasing drive voltage V_{S1} for a normally-off LC display can be viewed as a high brightness mode or an outdoor mode of operation for display system 100. In a process block 260, the brightness of lamp light 141 output from lamp source 140 can also be increased to further increase the overall brightness of image light 150 in bright, outdoor environments.

Returning to decision block 230, if controller 115 determines that ambient brightness has decreased, then process 201 continues to a process block 265. Since process 201 describes operation of display system 100 implemented with a LC display panel 135 having normally-off LC cells, the drive voltage V_{S1} is decreased in process block 265. Decreasing the voltage level of drive voltage V_{S1} causes the LC cells to block more lamp light 141 for a given image value resulting in a dimmer display, which reduces electrical cross-talk and power consumption. Decreasing drive voltage V_{S1} for a normally-off LC display can be viewed as a low brightness mode, power save mode, or an indoor mode of operation for display system 100. In a process block 270, the brightness of lamp light 141 output from lamp source 140 can also be decreased to further decrease the overall brightness of image light 150 in low light, indoor environments. Reducing the voltage level of drive voltage V_{S1} and potentially reducing the brightness of lamp light 141 both server to reduce power consumption. Accordingly, for a normally-off LC panel, the scaling of drive voltage V_{S1} affects the driving voltage applied to the entire LC display panel 135 to turn on selected LC cells. The scaling is applied across the entire gamma curve and affects LC cells that are entirely on or partially on according to the particular image value they are currently representing.

In one embodiment where LC display panel 135 is a color display, display panel power supply 120 outputs multiple independent drive voltages for independently driving the LC cells associated with each color. For example, for a color display having red, green, and blue pixels, display panel power supply 120 may output three drive voltages Vr, Vg, and Vb each corresponding to one of the different colors. In this embodiment, each of Vr, Vg, and Vb can be independently adjusted based upon the brightness signal output from ambient light sensor 110. By providing independent drive voltage scaling for each color of a color display, the color gamut of the color LC crystal display can be adjusted and tuned for different levels of ambient brightness.

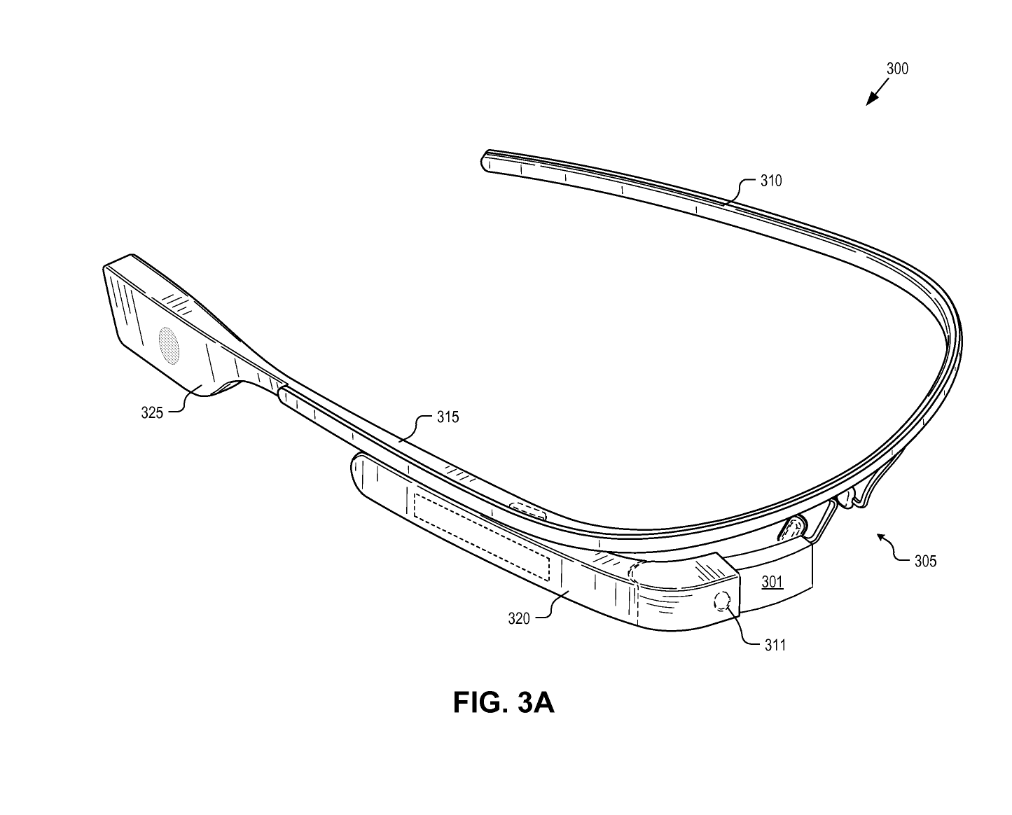

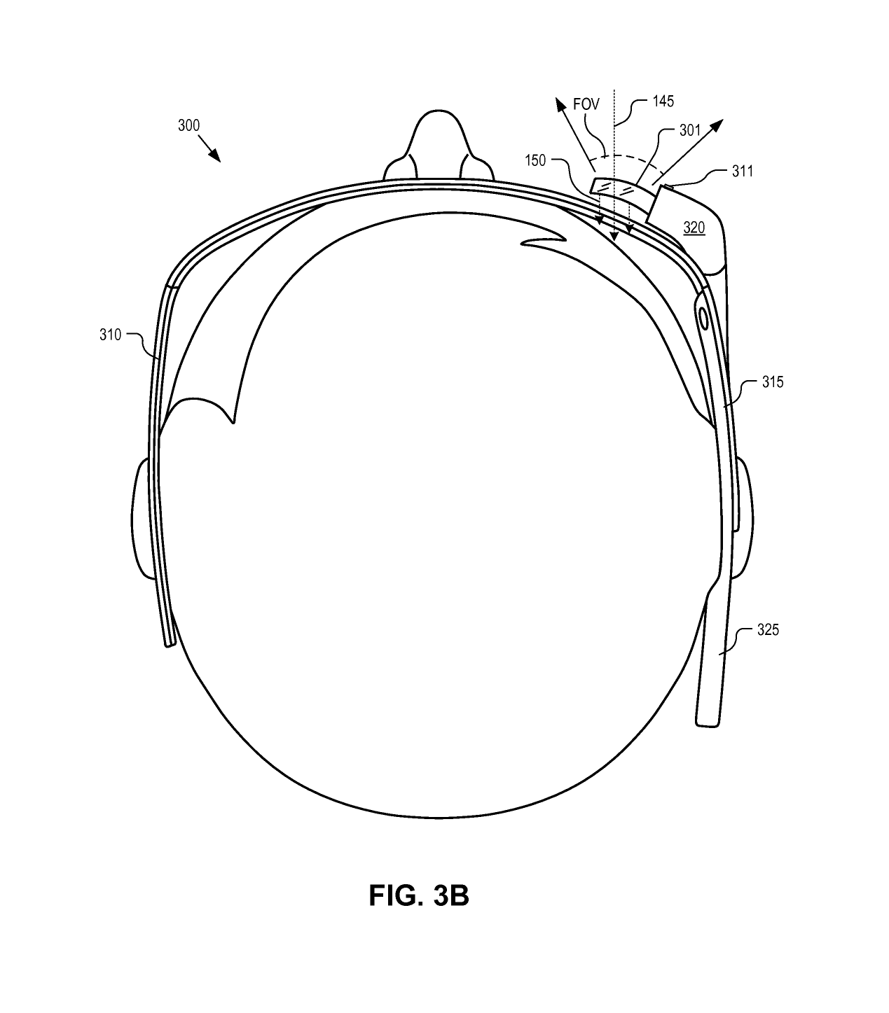

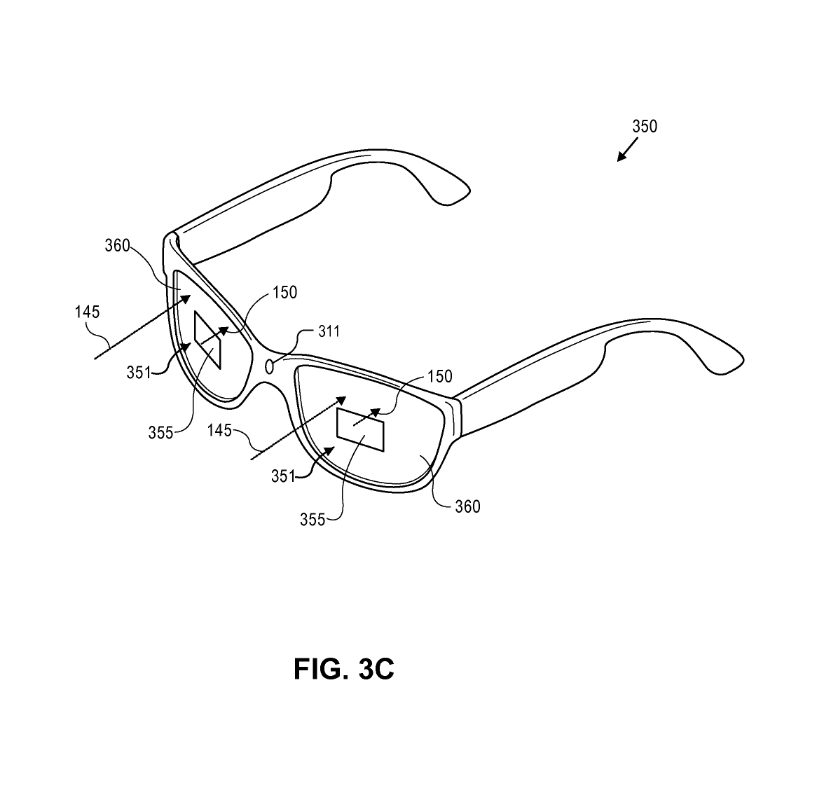

FIGS. 3A and 3B illustrate a demonstrative monocular head wearable display 300 including a see-through eyepiece 301, in accordance with an embodiment of the disclosure. FIG. 2A is a perspective view of head wearable display 300, while FIG. 2B is a top view of the same. See-through eyepiece 301 corresponds to see-through eyepiece 130 discussed above. Eyepiece 301 is mounted to a frame assembly, which includes a nose bridge 305, left ear arm 310, and right ear arm 315. Housings 320 and 325 may contain various electronics including controller 115, backlight power supply 125, display panel power supply 120, LC display source 105, ambient light sensor 110, as well as, other electronic components such as one or more wireless transceivers, a battery, a camera, a speaker, etc. In the illustrated embodiment, an ambient light sensor 311 (corresponding to an implementation of ambient light sensor 110) is disposed on the front side of housing 320 adjacent to see-through eyepiece 130 to sense the brightness of ambient light incident in an eye-ward direction within a FOV of see-through eyepiece 301.

The see-through eyepiece 301 is secured into an eye glass arrangement so head wearable display that can be worn on the head of a user. The left and right ear arms 310 and 315 rest over the user's ears while nose bridge 305 rests over the user's nose. The frame assembly is shaped and sized to position the viewing region of see-through eyepiece 301 in front of an eye of the user. Other frame assemblies having other shapes may be used (e.g., traditional eyeglasses frame, a single contiguous headset member, a headband, goggles type eyewear, etc.).

Although FIGS. 2A and 2B illustrate a monocular embodiment, head wearable display 300 may also be implemented as a binocular display with two see-through eyepieces 301 each aligned with a respective eye of the user when display 300 is worn. The monocular embodiment of FIGS. 2A and 2B is a compact see-through eyepiece that only covers a portion of the user's field of view. In other embodiments, the see-through eyepiece can be extended to form full eyeglass lenses in a binocular frame. FIG. 2C illustrates a binocular head wearable display 350 including two see-through eyepieces 351 that extend across a substantial portion of the user's field of view. See-through eyepeices 351 may each include optical combiner elements 355 disposed in the user's central vision to cover a large portion of their field of view. Optical combiner elements 355 may include beam splitters, polarizing beam splitters, diffractive gratings, holographic optical elements or otherwise that redirect display image 150 along an eye-ward direction and combine it with external scene image 145. Display image 150 may be launched into see-through eyepieces 351 at the peripheral temple regions and guided towards optical combiner elements 355 via total internal reflection. In other embodiments, the display image 150 may be emitted from the temple regions through free space onto the eye-ward side of optical combiner elements 355. A variety of different optical combiner techniques for combining external scene image 145 with display image 150 along an eye-ward direction into the user's eyes may be implemented. These full eyeglass see-through eyepieces may be implemented as prescriptive or non-prescriptive lenses.

The illustrated embodiment of head wearable displays 300 or 350 are capable of displaying an augmented reality to the user. See-through eyepieces 301 or 351 permit the user to see a real world image (external scene image 145). Left and right display images (binocular embodiment illustrated in FIG. 2C) may be generated by independent LC display sources 105 mounted in peripheral corners outside the user's central vision. Display light 150 is seen by the user as a virtual image superimposed over external scene image 145 as an augmented reality.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method for operation of a display system, the method comprising:
displaying a display image from a liquid crystal display source;
measuring a brightness of ambient light; and
selecting a drive voltage for driving liquid crystal cells within the liquid crystal display source based upon the brightness of the ambient light, wherein the drive voltage is used for driving the liquid crystal cells into an on-state or an off-state while displaying the display image.

2. The method of claim 1, further comprising:
monitoring the brightness of the ambient light for changes; and
adjusting the drive voltage for driving the liquid crystal cells when the brightness changes.

3. The method of claim 2, wherein adjusting the drive voltage for driving the liquid crystal cells when the brightness changes comprises adjusting the drive voltage by a pre-determined amount when the brightness changes by a threshold amount.

4. The method of claim 3, wherein the drive voltage has only two voltage levels and wherein a first voltage level of the drive voltage corresponds to a high brightness mode and a second voltage level of the drive voltage corresponds to a low brightness mode.

5. The method of claim 2, wherein adjusting the drive voltage for driving the liquid crystal cells when the brightness changes comprises continuously adjusting the drive voltage by variable amounts when the brightness changes by variable amounts.

6. The method of claim 2, wherein the liquid crystal cells comprise normally-on liquid crystal cells of a normally-on liquid crystal display panel and wherein adjusting the drive voltage for driving the liquid crystal cells when the brightness changes includes:
decreasing the drive voltage for driving the liquid crystal cells in response to the brightness of the ambient light increasing; and
increasing the drive voltage for driving the liquid crystal cells in response to the brightness of the ambient light decreasing.

7. The method of claim 2, wherein the liquid crystal cells comprise normally-off liquid crystal cells of a normally-off liquid crystal display panel and wherein adjusting the drive voltage for driving the liquid crystal cells when the brightness changes includes:
increasing the drive voltage for driving the liquid crystal cells in response to the brightness of the ambient light increasing; and
decreasing the drive voltage for driving the liquid crystal cells in response to the brightness of the ambient light decreasing.

8. The method of claim 2, wherein the display system comprises a head wearable display including a see-through eyepiece that combines an external scene view with the display image.

9. The method of claim 8, wherein the liquid crystal display source includes a liquid crystal display panel including the liquid crystal cells and a lamp source for generating lamp light to illuminate the liquid crystal display panel, the method further comprising:
increasing a brightness of the lamp light when the brightness of the ambient light increases; and
decreasing the brightness of the lamp light when the brightness of the ambient light decreases.

10. The method of claim 8, wherein measuring the brightness of the ambient light comprises measuring the brightness of the ambient light that is incident along an eye-ward direction within a field of view of the see-through eyepiece.

11. The method of claim 1, wherein the liquid crystal display source comprises a color display source having first color pixels, second color pixels, and third color pixels, wherein the first, second, and third color pixels have different associated colors, the method further comprising:
adjusting a first drive voltage for driving the liquid crystal cells of the first color pixels;
adjusting a second drive voltage for driving the liquid crystal cells of the second color pixels;
adjusting a third drive voltage for driving the liquid crystal cells of the third color pixels,
wherein the first, second, and third drive voltages are independently adjustable to tune a color gamut of the color display source.

12. A display system, comprising:
a liquid crystal display source including a liquid crystal display panel for generating a display image;
an ambient light sensor for measuring a brightness of ambient light;
a display panel power supply for driving liquid crystal cells within the liquid crystal display panel into an on-state or an off-state while generating the display image; and
a controller coupled to the ambient light sensor and the display panel power supply, the controller including logic that, when executed by the controller, will cause the display system to perform operations comprising:
monitoring the brightness of the ambient light for changes; and
adjusting the drive voltage for driving the liquid crystal cells when the brightness changes.

13. The display system of claim 12, wherein adjusting the drive voltage for driving the liquid crystal cells when the brightness changes comprises adjusting the drive voltage by a pre-determined amount when the brightness changes by a threshold amount.

14. The display system of claim 12, wherein the display panel power supply is coupled to generate multiple different voltage levels for driving the liquid crystal cells under control of the controller.

15. The display system of claim 12, wherein the liquid crystal cells comprise normally-on liquid crystal cells and wherein adjusting the drive voltage for driving the liquid crystal cells when the brightness changes includes:
decreasing the drive voltage for driving the liquid crystal cells in response to the brightness of the ambient light increasing; and
increasing the drive voltage for driving the liquid crystal cells in response to the brightness of the ambient light decreasing.

16. The display system of claim 12, wherein the liquid crystal cells comprise normally-off liquid crystal cells and wherein adjusting the drive voltage for driving the liquid crystal cells when the brightness changes includes:
increasing the drive voltage for driving the liquid crystal cells in response to the brightness of the ambient light increasing; and
decreasing the drive voltage for driving the liquid crystal cells in response to the brightness of the ambient light decreasing.

17. The display system of claim 12, wherein the display system comprises a head wearable display, the display system further comprising:
a see-through eyepiece that combines an external scene view with the display image; and
a frame for supporting the see-through eyepiece, the liquid crystal display source, the ambient light sensor, the display panel power supply, and the controller on a head of a user with the see-through eyepiece positioned in front of an eye of the user.

18. The display system of claim 17, wherein the liquid crystal display source includes a lamp source for generating lamp light to illuminate the liquid crystal display panel, and wherein the logic includes further logic that, when executed by the controller, will cause the display system to perform further operations comprising:
increasing a brightness of the lamp light when the brightness of the ambient light increases; and
decreasing the brightness of the lamp light when the brightness of the ambient light decreases.

19. The display system of claim 17, wherein the ambient light sensor is mounted to the frame in a position and with an orientation to measure the brightness of the ambient light that is incident along an eye-ward direction within a field of view of the see-through eyepiece.

20. The display system of claim 12, wherein the liquid crystal display source comprises a color display source having first color pixels, second color pixels, and third color pixels, wherein the first, second, and third color pixels have different associated colors, and wherein the logic includes further logic that, when executed by the controller, will cause the display system to perform further operations comprising:
adjusting a first drive voltage for driving the liquid crystal cells of the first color pixels;
adjusting a second drive voltage for driving the liquid crystal cells of the second color pixels;
adjusting a third drive voltage for driving the liquid crystal cells of the third color pixels,
wherein the first, second, and third drive voltages are independently adjustable to tune a color gamut of the color display source.

21. The display system of claim 12, wherein the liquid crystal display source comprises a backlit liquid crystal display or a liquid crystal on silicon display.
